(19) United States
(12) Patent Application Publication
(10) Pub. No.: US 2006/0225529 A1
(43) Pub. Date: Oct. 12, 2006

(54) Surgical holding device

(75) Inventors: Manfred Fischer, Tuttlingen (DE); Theodor Lutze, Balgheim (DE); Klaus Radermacher, Stolberg (DE); Markus Hahndorff, Aachen (DE); Wolfgang Lauer, Aachen (DE)

Correspondence Address: Lipsitz & McAllister, LLC, 755 MAIN STREET, MONROE, CT, 06468, US

(73) Assignees: AESCULAP AG & Co. KG, Tuttlingen (DE); RWTH Aachen, Aachen (DE)

(21) Appl. No.: 11/354,274

(22) Filed: Feb. 13, 2006

Related U.S. Application Data
(63) Continuation of application No. PCT/EP04/06209, filed on Jun. 9, 2004.

(30) Foreign Application Priority Data
Aug. 26, 2003 (DE) 103 40 151

(51) Int. Cl. G05G 1/00

(52) U.S. Cl. 74/469

(57) ABSTRACT

In order to improve a surgical holding device for holding a surgical instrument, with a frame, with a first linkage comprising at least two links, which articulatedly connects the frame to a first articulation point associated with the instrument, and with a second linkage comprising at least two links, which articulatedly connects the frame to a second articulation point associated with the instrument, so that a large range of action of the surgical instrument held by the holding device is adjustable as simply as possible, it is proposed that the links of the first linkage be mounted for pivotal movement about pivot axes relative to one another and relative to the frame, and that the pivot axes extend parallel to one another.

This application is a continuation of international application number PCT/EP2004/006209, filed on Jun. 9, 2004.

The present disclosure relates to the subject matter disclosed in international application number PCT/EP2004/006209 of Jun. 9, 2004 and German application number 103 40 151.2 of Aug. 26, 2003, which are incorporated herein by reference in their entirety and for all purposes.

### BACKGROUND OF THE INVENTION

The invention relates to a surgical holding device for holding a surgical instrument, with a frame, with a first linkage comprising at least two links, which articulatedly connects the frame to a first articulation point associated with the instrument, and with a second linkage comprising at least two links, which articulatedly connects the frame to a second articulation point associated with the instrument.

Such a holding device is known, for example, from US 2002/0038118 A1. This comprises two actuators rigidly connected to a base and two actuators movable relative to the actuators held on the base. The actuators held on the base comprise a translational drive. Translational drives have the disadvantage that they are relatively large and heavy, so that the fixed actuator must be of particularly stable construction. Furthermore, with the known device the two articulation points are only positionable within a very narrowly limited range, i. e., a radius of action of the surgical instrument is narrowly restricted.

The object of the present invention is, therefore, to so improve a surgical holding device of the kind described at the outset that a large range of action of the surgical instrument held by the holding device is adjustable as simply as possible.

### SUMMARY OF THE INVENTION

This object is accomplished, in accordance with the invention, with a surgical holding device of the kind described at the outset in that the links of the first linkage are mounted for pivotal movement about pivot axes relative to one another and relative to the frame, and in that the pivot axes extend parallel to one another. In accordance with the proposed arrangement, all links are adjustable in their position relative to the frame, i. e., also a link held on the frame is mounted pivotably relative to the frame. In this way, the first articulation point is movable within a range of action which comprises a maximum area with a maximum side length, which corresponds to a total length of the links arranged one behind the other. The parallel arrangement of the pivot axes also enables a movement of the first articulation point in a plane.

It is favorable for the links of the second linkage to be mounted for pivotal movement about pivot axes relative to one another and relative to the frame and for the pivot axes to extend parallel to one another. The second articulation point is thus movable in a simple way in a plane perpendicular to the pivot axes. The range of action of the second articulation point corresponds substantially to an area with a side length which corresponds to a length of the links of the second linkage arranged one behind the other.

It is advantageous for the two linkages to be configured such that the first articulation point is movable in a first plane of movement and the second articulation point in a second plane of movement. Independently of a configuration of the two articulation points, movements of the two articulation points can thus be carried out and also monitored in a particularly simple way, for example, by the holding device being employed in combination with a navigation system.

It is conceivable for the first plane of movement to be unchangeable relative to the second plane of movement. It is, however, advantageous for the first plane of movement to be movable relative to the second plane of movement. This makes it possible to keep the spacing between the two articulation points constant and to adapt a change in the spacing between the two articulation points, which is necessary when there is a change in the positions of the linkages.

The construction of the device becomes particularly simple when the first plane of movement is pivotable relative to the second plane of movement.

Furthermore, it is advantageous for a spacing between the first plane of movement and the second plane of movement to be alterable. In this way, a range of an angle of inclination of a longitudinal axis of the instrument relative to one of the pivot axes can be additionally enlarged.

It is advantageous for the frame to comprise a first and at least a second frame element and for the first linkage to be arranged on the first frame element and the second linkage on the second frame element. Thus, for example, the holding device could be attached to two different stand elements, which, in particular, provides spatial advantages in the case of many surgical operations.

For optimum adjustability of the arrangement, the first frame element can be mounted so as to be movable relative to the second frame element.

The frame elements can be mounted directly on one another or arranged at locations separate from one another.

A particularly simple construction of the device is obtained when the first frame element is pivotable about an axis of rotation relative to the second frame element. Such a pivotal mounting can be implemented in a simple way.

Although it is conceivable to provide the axis of rotation at right angles or at an inclination to the two planes of movement, it is particularly advantageous for the axis of rotation to extend parallel to the two planes of movement. A pivotal movement of the two planes of movement relative to each other can thus be implemented in a simple way.

It is favorable for the first frame element to be displaceable in a direction transverse to the first plane of movement relative to the second frame element. It is thus possible to change a spacing between the two frame elements, and a spacing between the two planes of movement is thereby also alterable. In turn, it is thus possible to bring about a necessary change in the spacing between the articulation points, which is required if the two articulation points are to be arranged at a fixed spacing from each other.

In accordance with a preferred embodiment of the invention it can be provided that the first linkage comprises five links pivotable relative to one another in the first plane of movement. With five such mounted links, the first articulation point can be positioned in the desired manner in the first plane of movement.

It is favorable for the five links of the first linkage to be connected to one another so as to form a closed first ring structure. This can be formed, for example, by each link comprising a first and a second end and by a first end of a link being connected to a second end of another link.

For a particularly compact design of the device, it is advantageous for the first frame element to comprise one of the first five links of the first linkage. This means that two links are pivotably mounted on the first frame element.

It is advantageous for the first articulation point to be associated with at least one of the links of the first linkage. It can, for example, be arranged directly on the link or be spaced from it by means of a further element. In any case it is favorable for a relative position of the first articulation point to remain constant relative to the at least one link of the first linkage.

To achieve optimum positioning of the second articulation point in the second plane of movement, it is favorable for the second linkage to comprise five links pivotable relative to one another in the second plane of movement. It is thus also possible to construct particularly compact and elongated linkages. A length of the links can be varied in accordance with requirements.

To obtain a particularly good guidance for the second articulation point, it is favorable for the five links of the second linkage to be connected to one another so as to form a closed ring structure. If, for example, the second articulation point is defined by a connection between two links, then the second articulation point is held and guided on both sides thereof.

The device can be made of particularly compact design when the second frame element comprises one of the five links of the second linkage. Such an arrangement could, for example, be configured such that two of the five links are pivotably mounted on the second frame element.

A defined positioning of the second articulation point is possible when the second articulation point is associated with at least one of the links of the second linkage. This could be a rigid association or an association which is alterable in its spacing.

The device makes do without any additional joints when the pivot axes of the links of the first linkage extend at right angles to the first plane of movement.

It is advantageous for the pivot axes of the links of the second linkage to extend at right angles to the second plane of movement. In this way, a movement of the second articulation point in the second plane of movement can be guided and its position held.

In principle, it is conceivable to move the links of the two linkages into a desired position by hand. It is, however, advantageous for at least one link drive to be provided for moving at least one link, mounted on the frame, of one of the two linkages. This enables a positioning of the first articulation point independently of manual intervention by an operator. In this way, for example, a position of a surgical instrument in a sterile area can be altered without an operator having to intervene in the sterile area.

To enable fully automatic adjustment of positions of the two articulation points in space, it is favorable for each of the two linkages to have two link drives associated with it. If all links of the linkage are connected to one another, this results, for example, in the case of five links, in a forced guidance of two non-driven links if the driven links are arranged on a fixed link.

It is conceivable to use linear drives as link drives. It is, however, advantageous for the at least one link drive to be a rotational drive for pivoting the at least one link mounted on the frame relative to the frame. A particularly compact construction is thereby achievable for the device since the drive does not have to be integrated in the link. As a result, the links can be of particularly slim and light design. Moreover, rotary joint-type rotational drives have less play than linear drives.

It is conceivable to arrange the link drive on a link. However, the at least one link drive is preferably arranged on the frame. It is thus possible to arrange the link drive outside an operating site, which significantly facilitates access to the operating site.

In order to implement a robot-like holding device, it is advantageous for the link drives to be activatable independently of one another. In this way, the two articulation points can be brought independently of each other into any desired position that is adjustable with the device.

It is conceivable to provide the two articulation points directly on the two linkages, for example, each on one respective link or each at one respective articulation point joining two links. It is, however, advantageous for each of the two linkages to carry a holding element and for each holding element to have one of the two articulation points associated with it. Thus, for example, a separation can be made in a simple way between a sterile area and a non-sterile area, which separate the holding element into two holding element sections, namely a sterile one and a non-sterile one. In addition, large distances between the linkage and the instrument can be set with the holding element.

In order to vary a spacing between the instrument and the linkage, the at least one holding element can be detachably connectable to one of the links. In order to arrange the device, for example, partly in a non-sterile area, but to keep the instrument in a sterile area, each holding element can comprise a sterile interface. This makes it possible to arrange the holding element partly in the sterile area where it holds the instrument, and partly in the non-sterile area where the linkage and also any link drives can be arranged.

The linkage is particularly compact when at least one of the two linkages comprises two intersecting links.

The design of the device is particularly simple when the device comprises only rotary joints for moving the links and the articulation points relative to one another. Rotary joints are particularly easy to construct, are almost play-free and, for example, in combination also enable movement about more than only one degree of freedom.

To allow almost optional adjustment of a position of the instrument, it is favorable for the first and/or second articulation point to comprise a joint with multiple degrees of freedom.

It is advantageous for the joint with multiple degrees of freedom to be a ball-and-socket joint. A mounting of the instrument on the holding device by means of a ball-and-socket joint enables an almost optional orientation of a longitudinal axis of the instrument in space. In this way, the joint can also be of particularly compact design.

It is favorable for the joint with multiple degrees of freedom to be in the form of a universal joint. Such a joint can be formed solely by rotary joints.

If the two planes of movement are not displaceable relative to each other, it is favorable for the instrument to be held at at least one of the two articulation points so as to be displaceable. Spacings between the two articulation points can thus be optionally adjusted.

In principle, the instrument could be held directly on the holding device. It is, however, advantageous for a guide to be provided for the instrument and for the two articulation points to be arranged on the guide. In this way, the guide can be positioned in space, and the instrument removed from it in a simple way. Furthermore, instruments can be exchanged particularly easily, namely by being removed from the guide and replaced by other instruments.

The following description of preferred embodiments of the invention serves in conjunction with the drawings to explain the invention in greater detail.

### BRIEF DESCRIPTION OF THE DRAWINGS

FIG. 1 shows a perspective front view from above of a holding device according to the invention;

FIG. 2 shows a perspective view of the holding device from behind;

FIG. 3 shows a view from above of the holding device;

FIG. 4 shows a side view of the holding device from FIG. 3;

FIG. 5 shows a plan view of a holding device with link positions changed with respect to one another;

FIG. 6 shows a side view of the holding device from FIG. 5; and

FIG. 7 shows a second embodiment of a holding device according to the invention.

### DETAILED DESCRIPTION OF THE INVENTION

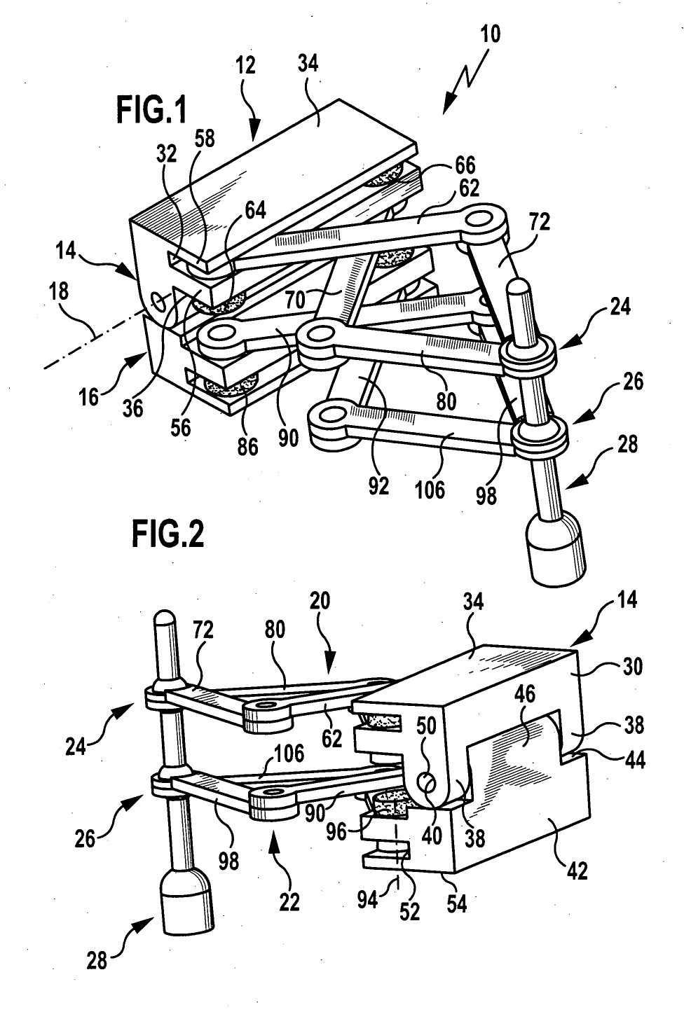

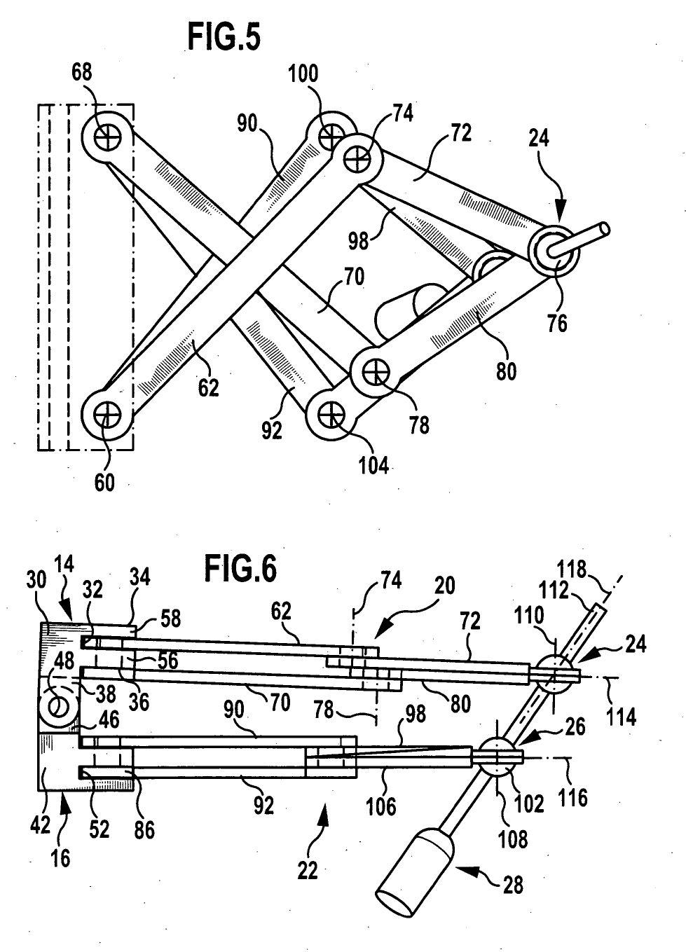

A motor-driven platform for supporting equipment, which can be coupled as a module to various surgical holding systems, is generally designated by reference numeral 10 in FIGS. 1 to 6. It comprises a two-part frame 12 with an upper frame half 14 and a lower frame half 16 mounted for pivotal movement about a frame pivot axis 18 relative to the upper frame half 14. There is associated with each of the two frame halves 14 and 16 a five-member crank mechanism 20 and 22, respectively. In the present embodiment, the crank mechanisms are of identical design. Furthermore, each of the two crank mechanisms 20 and 22 carries an articulation point 24 and 26, respectively, at which a surgical instrument 28, for example, in the form of a milling tool or an optical endoscope, is held.

The upper frame half 14 comprises a main body 30 of rectangular parallelepiped construction having on one of its narrow long sides a longitudinal groove 32 arranged in parallel with a top side 34 of the main body 30. Protruding at right angles from an underside 36 of the main body 30 are two bearing bolts 38, each of which is provided with a bore 40.

The lower frame half 16 comprises a main body 42, likewise of rectangular parallelepiped construction, from the top side 44 of which there protrudes at right angles a bearing bolt 46, likewise having a bore 48. The bearing bolt 46 is inserted between the two bearing bolts 38 and is held between these two so as to be immovable in the direction of the frame pivot axis 18. For this purpose, a cylindrical bearing shaft 50 is inserted in the bores 40 and 48 and rotationally fixedly connected to the bearing bolts 38. A longitudinal groove 52 arranged parallel to the underside 54 of the main body 42 is open in a direction away from a narrow long side surface of the main body 30.

In a position of the frame half 14 relative to the frame half 16, in which the top side 34 extends parallel to the underside 54, both longitudinal grooves 32 and 52 are aligned parallel to each other and facing in the same direction.

The crank mechanism 20 comprises a first link which is formed by a groove side wall 56 of the longitudinal groove 32. In the longitudinal groove 32, at one end thereof, a flat rectangular link 62 is arranged between the groove side wall 56 and a groove side wall 58 for pivotal movement about an axis of rotation 60 extending at right angles to the top side 34. By means of a rotational drive 64 the link 62 is pivotable around the axis of rotation 60, the rotational drive 64 also being arranged rotationally symmetrically in relation to the axis of rotation 60 on the underside 36.

In the longitudinal groove 32 at its other end there is arranged between the groove side walls 56 and 58 a second rotational drive 66, which drives an elongated rectangular link 70 mounted for pivotal movement about an axis of rotation 68 extending at right angles to the top side 34. A free end of the link 62 is articulatedly connected for pivotal movement about an axis of rotation 74 to a further elongated rectangular link 72, which is somewhat shorter than the link 62. A free end of the link 72 engages around a joint ball 76. A free end of the link 70 is articulatedly connected for pivotal movement about an axis of rotation 78 to a fifth link 80, which has an end engaging around the joint ball 76. The five-member crank mechanism 20 thus comprises a total of five links, namely the groove side wall 56 and the links 62, 72, 80 and 70.

The second five-member crank mechanism 22 comprises as stationary link a first groove side wall 82, facing in the direction towards the upper frame half 14, of the longitudinal groove 52, which also has a lower groove side wall 84. At one end of the longitudinal groove 52 there is arranged between the groove side walls 82 and 84 symmetrically with an axis of rotation 88 a rotational drive 86 which serves to drive an elongated link 90 of rectangular parallelepiped construction, which is mounted at the groove side wall 82 for pivotal movement about the axis of rotation 88. Between the two groove side walls 82 and 84 at another end of the longitudinal groove 52, there is mounted a further elongated link 92 of rectangular parallelepiped construction for pivotal movement about an axis of rotation 94. The link 92 is driven by a fourth rotational drive 96 which is arranged symmetrically with the axis of rotation 94. A free end of the link 90 is mounted on a somewhat shorter, elongated link 98 of rectangular parallelepiped construction for pivotal movement about an axis of rotation 100. A free end of the link 98 engages around a joint ball 102 of the articulation point 26. A free end of the link 92 is connected for pivotal movement about an axis of rotation 104 to a link 106, which has a free end engaging around the joint ball 102. In the area of the articulation point 26, the two links 90 and 106 therefore define a further axis of rotation 108, in the same way as the two links 72 and 78 define a common axis of rotation 110 in the area of the articulation point 24.

Each of the links 62, 70, 90 and 92 can also be optionally driven directly by a drive worm which is not illustrated.

The instrument 28 is held at the two articulation points 24 and 26 in a rotationally fixed manner at the joint balls 76 and 102. Rotation of a shaft 112 of the instrument 28 about a longitudinal axis 118 is possible as the joint balls 76 and 102 are mounted in a freely rotatable manner on the links 72, 80 and 98, 106, respectively.

Each crank mechanism 20 and 22, respectively, comprises two intersecting links, namely links 62 and 70 in crank mechanism 20 and links 90 and 92 in crank mechanism 22.

The crank mechanism 22 is of five-member construction and comprises the groove side wall 82 and links 90, 98, 106 and 92.

The axes of rotation 60, 74, 110, 78 and 68 of the crank mechanism 20 are all orientated parallel to one another and perpendicularly to the top side 34 of the upper frame half 14. The axes of rotation 88, 100, 108, 104 and 94 are likewise aligned parallel to one another and at right angles to the underside 54 of the lower frame half 16. Consequently, the articulation point 24 can be moved in a first plane 114 and the second articulation point 26 in a second plane 116 by means of the two crank mechanisms 20 and 22, respectively.

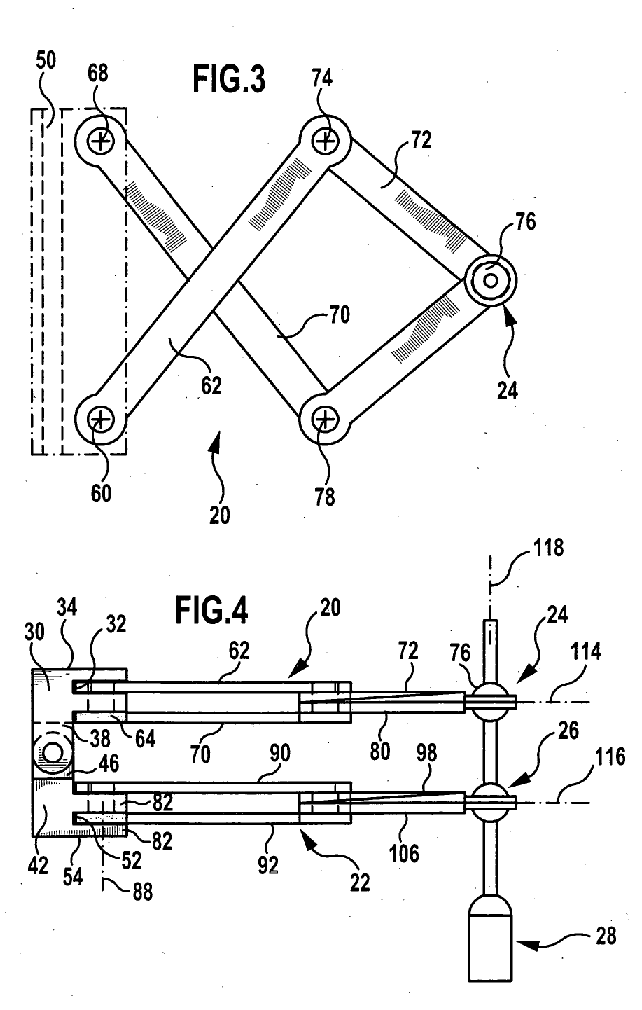

The link 62 is freely pivotable by means of the rotational drive 64. In the same way, the link 70 is pivotable by means of the rotational drive 66. As free ends of the links 72 and 80 are connected to one another for pivotal movement about the axis of rotation 110, a forced guidance results for the articulation point 24. The more parallel the links 62 and 70 become aligned to each other, the further does the articulation point 24 move away from the frame 12. If, as shown in FIGS. 1 to 6, the two crank mechanisms 20 and 22 are of identical design, and if they are initially identically adjusted in their relative positions, then the longitudinal axis 118 of the shaft 112 initially runs parallel to the axis of rotation 110. This position is shown in FIGS. 3 and 4.

If the crank mechanism 22 remains unchanged, but the links 62 and 70 are pivoted relative to each other, so that the axes of rotation 74 and 78 move closer together, then the articulation point 24 is moved away from the frame 12. As a result, the longitudinal axis 118 of the shaft 112 tilts relative to the axis of rotation 110. As the distance between the joint balls 76 and 102 is fixedly predetermined and, therefore, constant because the shaft 112 is rotationally fixedly connected to the joint balls 76 and 102, the frame half 14 tilts relative to the frame half 16 by pivoting about the frame pivot axis 18.

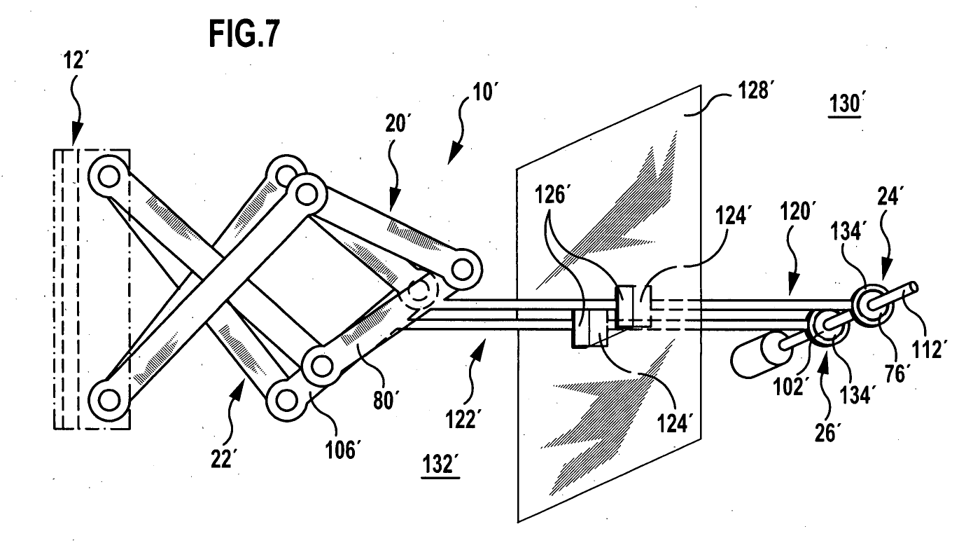

FIG. 7 shows a slightly modified platform for supporting equipment, which is generally designated by reference numeral 10′. Two crank mechanisms 20′ and 22′ are held in the above-described manner on a frame 12′. From the link 80′ there protrudes at an incline a two-part spacer, generally designated by reference numeral 120′, and in a similar way a spacer 122′ from link 106′. The spacers 120′ and 122′ are in the form of elongated bars which are joined to each other at approximately the center by a two-part plug connection comprising a plug 124′ and a socket 126′. A sterile foil 128′, which separates a sterile area 130′ from a non-sterile area 132′, is clampable between the plugs 124′ and the sockets 126′. Free ends of the spacers 120′ and 122′ carry the articulation points 24′ and 26′ which are defined by bearing rings 134′ held at a free end of the spacers 120′ and 122′ and joint balls 76′ and 102′ surrounded by bearing rings 134′. The shaft 112′ of the instrument 28′ is rotationally fixedly connected to the joint balls 76′ and 102′.

The instrument 28′ can be held in a desired setting and position in a sterile area 130′ by means of the platform 10′ for supporting equipment. In this case, the crank mechanisms 20′ and 22′ are located in a non-sterile area, which may also be outside an operating site.

1. Surgical holding device for holding a surgical instrument, with a frame, with a first linkage comprising at least two links, which articulatedly connects the frame to a first articulation point associated with the instrument, and with a second linkage comprising at least two links, which articulatedly connects the frame to a second articulation point associated with the instrument, wherein the links of the first linkage are mounted for pivotal movement about pivot axes relative to one another and relative to the frame, and the pivot axes extend parallel to one another.

2. Device in accordance with claim 1, wherein the links of the second linkage are mounted for pivotal movement about pivot axes relative to one another and relative to the frame, and the pivot axes extend parallel to one another.

3. Device in accordance with claim 1, wherein the two linkages are configured such that the first articulation point is movable in a first plane of movement and the second articulation point in a second plane of movement.

4. Device in accordance with claim 3, wherein the first plane of movement is movable relative to the second plane of movement.

5. Device in accordance with claim 4, wherein the first plane of movement is pivotable relative to the second plane of movement.

6. Device in accordance with claim 4, wherein a spacing between the first plane of movement and the second plane of movement is alterable.

7. Device in accordance with claim 1, wherein the frame comprises a first and at least a second frame element, and the first linkage is arranged on the first frame element and the second linkage on the second frame element.

8. Device in accordance with claim 7, wherein the first frame element is mounted so as to be movable relative to the second frame element.

9. Device in accordance with claim 8, wherein the first frame element is pivotable about an axis of rotation relative to the second frame element.

10. Device in accordance with claim 9, wherein the axis of rotation extends parallel to the two planes of movement.

11. Device in accordance with claim 8, wherein the first frame element is displaceable in a direction transverse to the first plane of movement relative to the second frame element.

12. Device in accordance with claim 1, wherein the first linkage comprises five links pivotable relative to one another in the first plane of movement.

13. Device in accordance with claim 12, wherein the five links of the first linkage are connected to one another so as to form a closed first ring structure.

14. Device in accordance with claim 12, wherein the first frame element comprises one of the five links of the first linkage.

15. Device in accordance with claim 1, wherein the first articulation point is associated with at least one of the links of the first linkage.

16. Device in accordance with claim 1, wherein the second linkage comprises five links pivotable relative to one another in the second plane of movement.

17. Device in accordance with claim 16, wherein the five links of the second linkage are connected to one another so as to form a closed second ring structure.

18. Device in accordance with claim 16, wherein the second frame element comprises one of the five links of the second linkage.

19. Device in accordance with claim 1, wherein the second articulation point is associated with at least one of the links of the second linkage.

20. Device in accordance with claim 3, wherein the pivot axes of the links of the first linkage extend at right angles to the first plane of movement.

21. Device in accordance with claim 3, wherein the pivot axes of the links of the second linkage extend at right angles to the second plane of movement.

22. Device in accordance with claim 1, wherein at least one link drive is provided for moving at least one link, mounted on the frame, of one of the two linkages.

23. Device in accordance with claim 22, wherein each of the two linkages has two link drives associated with it.

24. Device in accordance with claim 22, wherein the at least one link drive is a rotational drive for pivoting the at least one link mounted on the frame relative to the frame.

25. Device in accordance With claim 22, wherein the at least one link drive is arranged on the frame.

26. Device in accordance with claim 22, wherein the link drives are activatable independently of one another.

27. Device in accordance with claim 1, wherein each of the two linkages carries a holding element, and each holding element has one of the two articulation points associated with it.

28. Device in accordance with claim 27, wherein the at least one holding element is releasably connectable to one of the links.

29. Device in accordance with claim 27, wherein each holding element comprises a sterile interface.

30. Device in accordance with claim 1, wherein at least one of the two linkages comprises two intersecting links.

31. Device in accordance with claim 1, wherein the device comprises only rotary joints for moving the links and the articulation points relative to one another.

32. Device in accordance with claim 1, wherein the first and/or the second articulation point comprises a joint with multiple degrees of freedom.

33. Device in accordance with claim 32, wherein the joint with multiple degrees of freedom is a ball-and-socket joint.

34. Device in accordance with claim 32, wherein the joint with multiple degrees of freedom is in the form of a universal joint.

35. Device in accordance with claim 1, wherein the instrument is held displaceably at at least one of the two articulation points.

36. Device in accordance with claim 35, wherein a guide is provided for the instrument, and the two articulation points are arranged on the guide.
